(19) United States
(12) Patent Application Publication
(10) Pub. No.: US 2023/0244071 A1
(43) Pub. Date: Aug. 3, 2023

(54) SAMPLE PLATE FOR A MICROSCOPE, AN INTERFERENCE REFLECTIVE MICROSCOPE SYSTEM COMPRISING SUCH A SAMPLE PLATE AND A BRIGHTFIELD MICROSCOPE SYSTEM COMPRISING SUCH A SAMPLE PLATE

(71) Applicant: CITY UNIVERSITY OF HONG KONG, Kowloon (HK)

(72) Inventors: Raymond Hiu-Wai LAM, Kowloon (HK); Yi LIU, Kowloon (HK)

(21) Appl. No.: 18/150,130

(22) Filed: Jan. 4, 2023

Related U.S. Application Data
(60) Provisional application No. 63/304,479, filed on Jan. 28, 2022.

(51) Int. Cl. G02B 21/34; G02B 21/00

(52) U.S. Cl. CPC G02B 21/34; G02B 21/0032; G02B 21/0056

(57) ABSTRACT

A sample plate for a microscope comprising an optically transparent substrate comprising first and second faces; the first face comprising a recess wall defining a concave recess for receiving a microscope sample; and, a lens extending from the second face, the lens being defined by a lens face; the lens being arranged opposite the recess.

### CROSS-REFERENCE TO RELATED APPLICATIONS

The present application claims priority to United States Provisional Application No. U.S. 63/304,479 filed with the United States Patent and Trademark Office on Jan. 28, 2022 and entitled “MICROLENS ARRAYS FOR CHARACTERIZATION OF CELL BEHAVIOR ON CURVED MICROTOPOGRAPHY,” which is incorporated herein by reference in its entirety for all purposes.

### FIELD OF THE INVENTION

The present invention relates to a sample plate for a microscope. More particularly, but not exclusively, the present invention relates to a sample plate for a microscope comprising optically transparent substrate comprising first and second faces, the first face comprising a recess wall defining a concave recess for receiving a microscope sample, the sample plate further comprising a lens extending from the second face opposite to the recess. The present invention also relates to an interference reflective microscope system comprising such a sample plate. The present invention also relates to a brightfield microscope system comprising such a sample plate.

### BACKGROUND

Cell adhesion dynamics and morphology have been considered to be the critical cellular response to the surrounding microenvironment. Existing imaging techniques for investigating extracellular matrix (ECM) biophysical and biochemical cues on cell response behaviour mainly rely on scanning electron microscopy (SEM) and immunofluorescence. However, both of these techniques require cell fixation. Interference reflective microscopy enables the observation of live cells however imaging is restricted to flattened surfaces or nano roughened surfaces.

The present invention seeks to overcome the problems of the prior art.

### STATEMENT OF INVENTION

Accordingly, in a first aspect the present invention provides a sample plate for a microscope comprising: an optically transparent substrate comprising first and second faces; the first face comprising a recess wall defining a concave recess for receiving a microscope sample; and, a lens extending from the second face, the lens being defined by a lens face; the lens being arranged opposite the recess

The sample plate according to the invention provides a non-flat surface for the microscope sample and can be used in an interference reflective microscope system. The invention essentially enables the extension of a two-dimensional imaging technique into three dimensions which makes complex studies such as cell adherent dynamics on non-flat surfaces possible. It enables, for example, real time imaging for quantifying cell spreading properties on 3D microstructures.

Preferably the lens extends integrally from the second face.

Preferably the recess wall is shaped as a portion of the surface of a sphere

Preferably the lens face is shaped as a portion of the surface of a sphere

Preferably the lens and the recess are dimensioned such that the focal point of the lens coincides with the center of curvature of the recess.

Preferably the lens face extends from a lens face edge to a lens face center, the lens being dimensioned such that when measured at the center of curvature of the lens, the angle between the lens face edge and the lens face center is less than π/4 radians

Preferably the recess is a groove and the lens is a ridge, the groove and ridge extending along a length direction.

Preferably the recess wall is shaped such that in a plane normal to the length direction the recess wall is a portion of a circle.

Preferably the lens wall is shaped such that in the plane normal to the length direction the ridge wall is a portion of a circle.

Preferably the lens and the recess are dimensioned such that the focal point of the lens coincides with the center of curvature of the recess.

Preferably in the plane normal to the length direction the lens face extends from a lens face edge to a lens face center, the lens being dimensioned such that when measured at the center of curvature of the lens the angle between the lens face edge and the lens face center is less than π/4 radians.

Preferably the substrate is a silicon based organic polymer, preferably polydimethylsiloxane.

Preferably the first face comprises a plurality of recess walls defining a plurality of spaced apart recesses, the sample plate further comprising a plurality of lenses extending from the second face, each lens being arranged opposite a recess.

In a further aspect of the invention there is provided an interference reflective microscope system comprising: a sample plate for a microscope comprising an optically transparent substrate comprising first and second faces; the first face comprising a recess wall defining a concave recess for receiving a microscope sample; and, a lens extending from the second face, the lens being defined by a lens face; the lens being arranged opposite the recess; a monochromatic light source configured to illuminate the lens in a direction substantially normal to the second face; and, an optical imaging system configured to receive the light reflected from the lens in a direction substantially normal to the second face.

The interference reflective microscope system according to the invention can image a sample on the curved recess wall. Amongst other things this makes complex studies such as cell adherent dynamics on non-flat surfaces feasible.

Preferably the monochromatic light source comprises a laser.

Preferably the monochromatic light source comprises a confocal scanning laser system.

Preferably the optical imaging system comprises a photomultiplier tube.

Preferably the interference reflection microscope system further comprises a second optical imaging system configured to receive light from the monochromatic light source transmitted through the sample plate.

In a further aspect of the invention there is provided a brightfield microscope system comprising: a sample plate for a microscope comprising an optically transparent substrate comprising first and second faces; the first face comprising a recess wall defining a concave recess for receiving a microscope sample; and, a lens extending from the second face, the lens being defined by a lens face; the lens being arranged opposite the recess; a monochromatic light source configured to illuminate the concave recess in a direction substantially normal to the first face; and, an optical imaging system configured to receive the light transmitted through the sample plate.

### BRIEF DESCRIPTION OF DRAWINGS

The present invention will now be described by way of example only and not in any limitative sense with reference to the accompanying drawings in which

FIG. 1 shows, in vertical cross section a portion of a sample plate for a microscope according to the invention;

FIGS. 2(a) to 2(i) show a method of manufacture of a sample plate according to the invention;

FIG. 3 shows an interference reflection microscope system (IRM system) according to the invention;

FIG. 4 shows the passage of light through the sample plate of the IRM system of FIG. 3;

FIGS. 5(a) and 5(b) show lenses of sample plates according to the invention;

FIG. 6 shows the first face of a further embodiment of a sample plate according to the invention;

FIG. 7(a) shows in vertical cross section a brightfield microscope system according to the invention; and,

FIG. 7(b) shows a portion of a sample plate of the system of FIG. 7(a).

### DESCRIPTION OF EMBODIMENTS

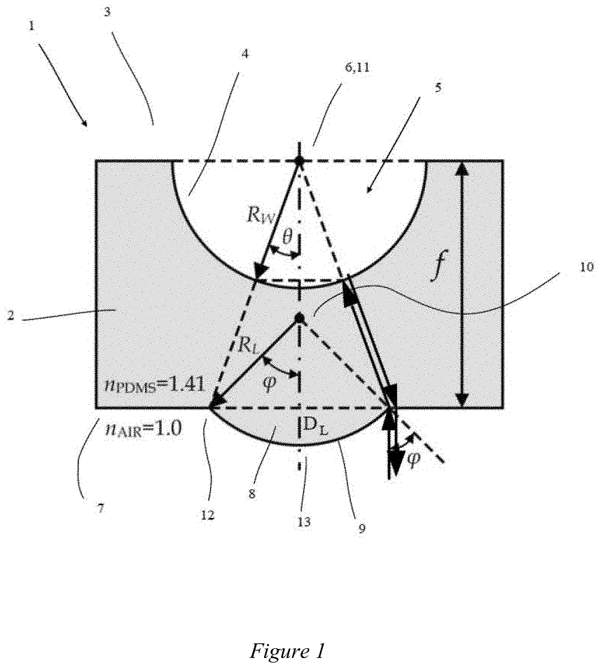

Shown in FIG. 1, in vertical cross section, is a portion of a sample plate 1 according to the invention. The sample plate 1 comprises an optically transparent substrate 2. The substrate 2 is typically a silicon based organic polymer, preferably polydimethylsiloxane.

The substrate 2 comprises a first face 3 which in this embodiment is substantially flat. The first face 3 comprises a plurality of recess walls 4 each of which defines a recess 5 for receiving a microscope sample. The recesses 5 are arranged in a regularly spaced array. Only one such recess 5 is shown. In this embodiment each recess wall 4 is shaped as a portion of a surface of a sphere. Each recess 5 therefore has a center of curvature 6 which is equidistant from all points of the recess wall 4, the distance being the radius of curvature R_{w} of the recess 5.

The substrate 2 further comprises a second face 7 which is spaced apart from and substantially parallel to the first face 3. Extending from the second face 7 are a plurality of lenses 8, the shape of each lens 8 being defined by a lens face 9. Each lens 8 is arranged opposite a corresponding recess 5 as shown. Each lens 8 extends integrally from the substrate 2. Only one lens 8 is shown.

In this embodiment each lens face 9 is shaped as the portion of the surface of a sphere. Each lens 8 therefore has a center of curvature 10 which is equidistant from all points of the lens face 9, the distance being the radius of curvature R_{L} of the lens 8. For each lens/recess pair 8/5 the lens 8 and recess 5 are dimensioned such that the focal point 11 of the lens 8 coincides with the center of curvature 6 of recess 5 as is discussed in more detail below.

For each lens 8 the lens face 9 extends from a lens face edge 12 to a lens face center 13. The lens face edge 12 is the line along which the lens face 9 meets the second face 7 of the substrate 2. The lens face center 13 is the point equidistant from the points of the lens face edge 12 and is the point furthest from the second face 7. In this embodiment each lens 8 is dimensioned such that when measured at the center of curvature 10 of the lens 8, the angle φ between the lens face edge 12 and the lens face center 13 is less than π/4 radians. Again, this is discussed in more detail below.

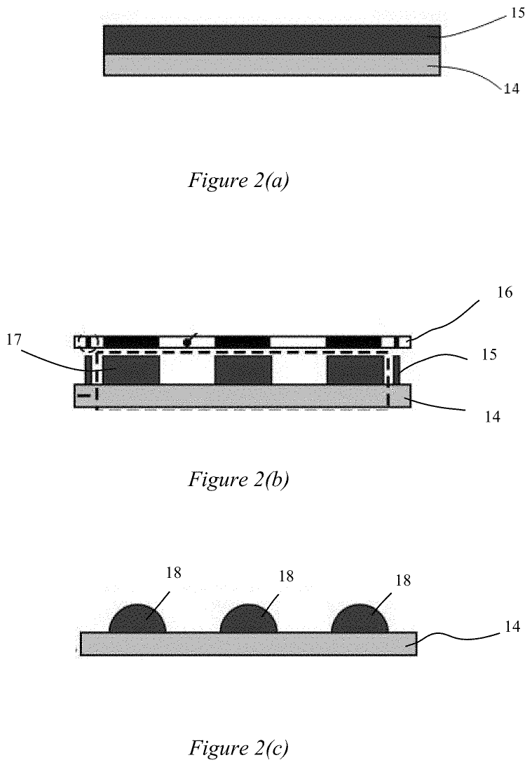

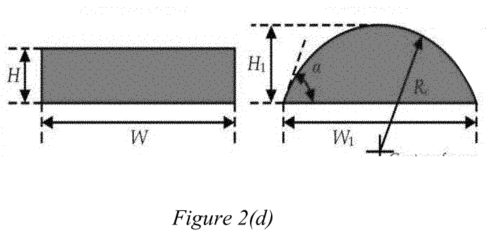

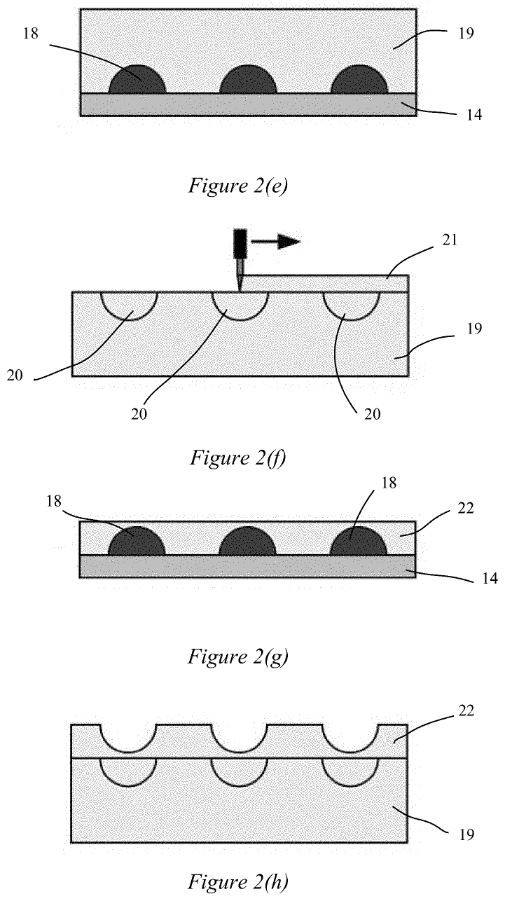

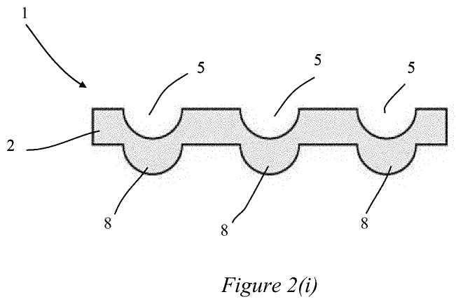

FIGS. 2(a) to 2(i) show a method of manufacture of a sample plate 1 according to the invention. In a first step adhesion promoter hexamethyldisilazane (HMDS) is spin coated onto a silicon wafer 14. A photoresist 15 (in this embodiment AZ-50XT) is then spin coated onto the wafer 14 followed by a baking step before the wafer 14 is allowed to cool. The wafer 14 at this point in the method of manufacture is shown in FIG. 2(a).

In a next step a UV mask 16 is arranged on the photoresist layer 15. The UV mask 16 is illuminated with UV light and then developed in a developing solution to remove portions of the photoresist layer 15 so leaving cylindrical columns 17 of photoresist layer 15 as shown in FIG. 2(b).

In a next step the wafer 14 is mounted on a hotplate and heated to produce thermal reflow of the columns 17 of photoresist, converting the columns 17 into spherical caps 18, as shown in FIG. 2(c).

The columns 17 of photoresist before and after reflow are shown in FIG. 2(d). Before thermal reflow the volume of the photoresist is the volume of the cylinder

$${V}_{photoresist} = {π ( \frac{W}{2} )}^{2} H$$

Where W is the diameter of the patterned photoresist cylinder and H is the photoresist deposited height.

After thermal reflow the volume of the spherical cap 18 is

$${V}_{c o n v e x} = \frac{π}{3} {R}_{c}^{3} ( 2 + cos α ) {( 1 - cos α )}^{2}$$

Referring to FIG. 2(d), H₁ is the height of the spherical cap, W₁ is the diameter of the base of the spherical cap 18, R_{c} is the radius of curvature of the spherical cap 18 and a is the contact angle between the spherical cap 18 and silicon wafer 14.

Assuming the volume of photoresist remains constant during the thermal reflow process ie V_{convex}=Vₚₕₒₜₒᵣₑₛᵢₛₜ and assuming W=W₁ then one can express the radius of curvature of the spherical cap 18 in terms of the height H of the photoresist columns 17 as

$${R}_{c} = \frac{3}{4} \frac{{sin}^{2} α}{( 2 + cos α ) {( 1 - cos α )}^{2}} H$$

In the next step the silicon wafer 14 is silanized with trichloro (1H, 1H, 2H, 2H-perfluoro-octyl) silane. This ensures convenient removal of polydimethylsiloxane (PDMS) from the wafer 14.

A prepolymer is then prepared by mixing PDMS monomer with a curing agent. This prepolymer is then poured onto the silicon wafer 14 and baked as shown in FIG. 2(e). The PDMS on the silicon wafer 14 is referred to as the PDMS negative mold 19.

The PDMS negative mold 19 is then stripped from the silicon wafer 14 and silanized again with trichloro (1H, 1H, 2H, 2H-perfluoro-octyl) silane. The PDMS negative mold 19 is then spin coated with PDMS, so filling the recesses 20 in the PDMS negative mold. Excess PDMS 21 is removed as shown in FIG. 2(f).

In a next step a microwell membrane 22 is created by spin coating the PDMS prepolymer onto the silicon wafer 14 and spherical cap 18 as shown in FIG. 2(g). This is then baked to cure before being stripped from the silicon wafer 14. The microwell membrane 22 is then aligned on the PDMS negative mold 19 as shown in FIG. 2(h) and cured. Finally, the PDMS negative mold 19 is removed as shown in FIG. 2(i) so leaving a sample plate 1 according to the invention.

The sample plate 1 is then bonded on a confocal dish (not shown) and treated with oxygen plasma. The plasma bonded device is then placed on a hotplate and heated to strengthen the bonding before finally being immersed in a mixture of fibronectin and water.

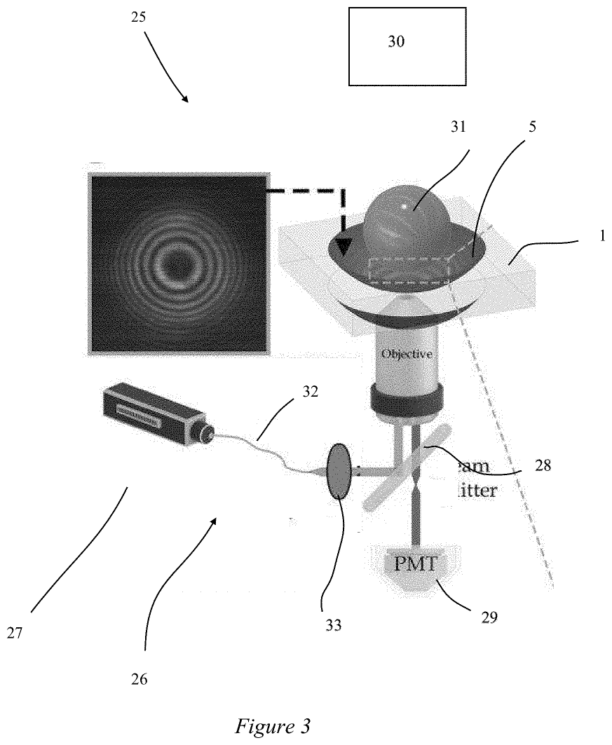

Shown in FIG. 3 is an interference reflective microscope system 25 (IRM system) according to the invention. The principles of operation of IRM microscopes are well known and so will not be described in detail. The system 25 comprises the sample plate 1 for a microscope as shown in FIG. 1. Only one recess/lens pair 5/8 is shown for clarity. The IRM system 25 further comprises a monochromatic light source 26 which in this embodiment is a confocal scanning laser system 27 and beam splitter 28. The IRM system 25 further comprises first and second optical imaging systems 29,30 which comprise first and second photomultiplier tubes 29,30 respectively.

In use an object 31 to be imaged, typically one or more cells, is arranged in the recess 5. The laser 27 provides high coherence monochromatic light (in this case far red light at 638 nm). This light is provided by means of an optical fibre 32 to a beam expander 33 and from there to the beam splitter 28. At the beam splitter 28 the light is reflected. The beam splitter 28 is arranged such that the light is incident onto the lens 8 substantially normal to the second face 7.

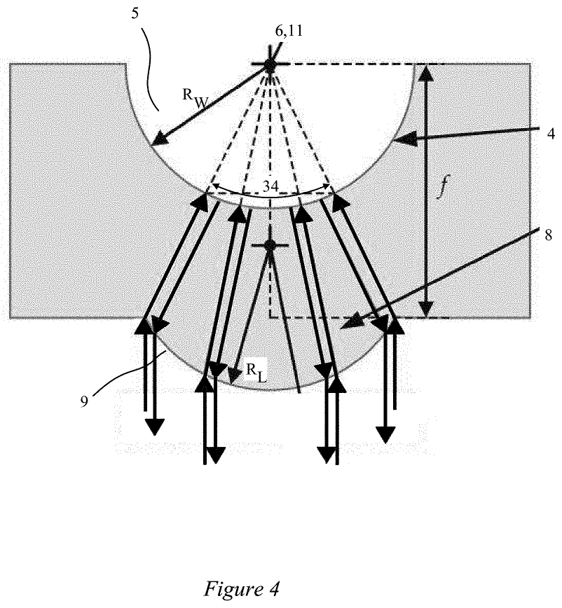

The passage of the light through the sample plate 1 is shown schematically in FIG. 4. Light which is incident on the lens 8 is refracted at the air/lens face 9 interface. Referring back to FIG. 1, the focal length ƒ of the lens 8 can be calculated from ƒ=R_{L}/n−1 where R_{L} is the radius of curvature of the lens 8 and n is the refractive index of the substrate 2. Returning to FIG. 4, the light is also partly reflected at this interface according to Snell's Law. The refracted light then reaches the recess wall/cell interface. The reflected light at this interface is reflected back on its incident path since the focal point 11 of the lens 8 coincides with the center of curvature 6 of the recess 5. Due to the refraction, only a portion of the recess wall 4 can be reflected back. This portion is the imaging portion 34 which is shaped as a spherical cap.

Light which is reflected at the recess wall/cell interface is reflected back to the beam splitter 28. This light passes through the beam splitter 28 and is received by a first optical imaging system 29. In this embodiment the first optical imaging system 29 comprises a first photomultiplier tube 29. Light which is transmitted through the sample plate 1 is received by a second optical imaging system 30 which comprises a second photomultiplier tube 30. By scanning the laser 27 over the imaging area 34 and recording the outputs of the first and second photomultiplier tubes 29,30 one can generate first and second images. The first image records detail of the recess wall/cell interface. The second image records cell relative location and diameter location.

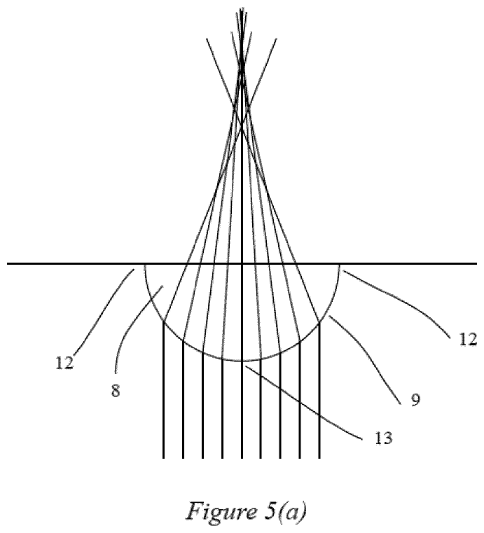

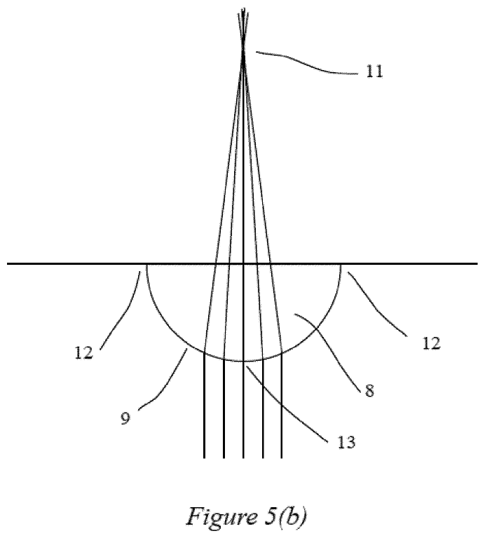

The lens face 9 is shaped as a portion of a sphere. As is known such lenses 8 potentially suffer from spherical aberration. Light which is incident on the lens 8 proximate to the lens face edge 12 is refracted by a greater degree than light near the lens face center 13. Not all light therefore focusses on the same focal point 11 as shown in FIG. 5(a). The solution to this problem is to restrict the size of the lens 8. As is known, one can substantially eliminate the problem of spherical aberration if one dimensions the lens 8 such that when measured at the center of curvature 10 of the lens 8 the angle φ between the lens face edge 12 and the lens face center 13 is less than π/4 radians. Referring back to FIG. 1 this is equivalent to dimensioning the lens such that for all points on the lens 8, sin φ≈φ. The lens 8 can be made larger than this in which case only the portion of the lens face 9 which obeys this relation is illuminated in use, as shown in FIG. 5(b).

Assuming that the lens 8 is dimensioned such that when measured at the center of curvature 10 of the lens 8 the angle φ between the lens face edge 12 and lens face center 13 is π/4 then one can calculate the area S_{W} of the imaging portion 34. Referring back to FIG. 1, S_{W} can be determined as

S_{W}=2πR_{W}²(1−cos θ)

Where θ is the polar intersection angle between the edge of the spherical cap and lens face center 13 measured at the center of curvature 6 of the recess 5.

Further,

$$cos φ = \frac{{R}_{L} - {D}_{L}}{{R}_{L}}$$

$$tan θ = \frac{\sqrt{{R}_{L}^{2} - {( {R}_{L} - {D}_{L} )}^{2}}}{{H}_{substrate}} = \frac{\sqrt{{R}_{L}^{2} - {( {R}_{L} - {D}_{L} )}^{2}}}{f}$$

Where D_{L} is the height of the lens above the second face 7, ƒ=R_{L}n_{Air}/(n_{PDMS}−n_{Air}), n_{Air}=1 and n_{PDMS}=1.41. Further,

$$\sqrt{{R}_{L}^{2} - {( {R}_{L} - {D}_{L} )}^{2}} = {R}_{L} sin φ$$

$$tan θ = \frac{( {n}_{P D M S} - 1 ) {R}_{L} sin φ}{{R}_{L}} = ( {n}_{P D M S} - 1 ) sin φ$$

From Snells law the angles θ and φ are related by the equation

n_{Air} sin φ=n_{PDMS} sin(φ−θ)

Hence, the area S_{W} can be expressed as

$${S}_{W} = 2 π {R}_{W}^{2} ( 1 - \frac{1}{\sqrt{1 + {tan}^{2} θ}} ) = 2 π {R}_{W}^{2} ( 1 - \frac{1}{\sqrt{1 + {( {n}_{P D M S} - 1 )}^{2} {sin}^{2} θ}} )$$

Assuming φ has the maximum angle of 45° then the maximum aperture angle can be calculated as

$$θ = 45 ° - arcsin ( \frac{\sqrt{2}}{2} / {n}_{P D M S} ) \approx 15 °$$

S_{W} can therefore be simplified to

$${S}_{W} = 2 π {R}_{W}^{2} ( 1 - \frac{1}{\sqrt{1 + \frac{1}{2} {( {n}_{P D M S} - 1 )}^{2}}} )$$

For a PDMS substrate 2 the imaging area is

S_{W}=0.08πR_{W}²

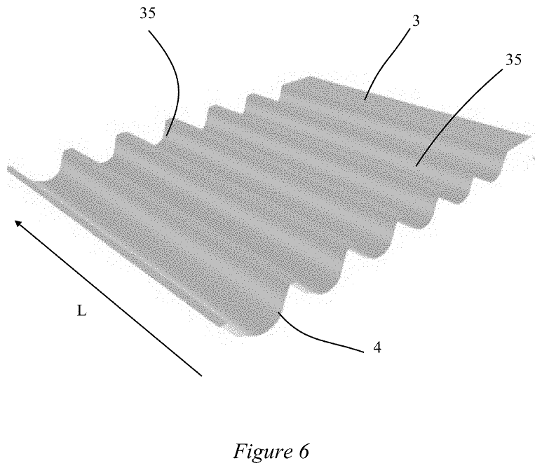

The sample plate 1 for a microscope described above comprises recess walls 4 and lens faces 9 which are each shaped as a portion of the surface of a sphere. The invention is not so limited. In an alternative embodiment of the invention the sample plate 1 comprises a plurality of recesses 5 shaped as grooves 35 and a plurality of lenses 8 shaped as ridges, the grooves 35 and ridges extending along a length direction L. The first face 3 of the substrate 2 comprising the grooves 35 is shown in FIG. 6. In a plane normal to the length direction L the recess walls 4 are shaped such that they are each a portion of a circle. Similarly, in the plane normal to the length direction the lens faces 9 are shaped as portions of circles.

An advantage of the sample plate 1 for a microscope according to the invention is that is can be customised in size depending on the application and is suitable for any adherent cell type. Further, the sample plate 1 for a microscope can be manufactured in a straightforward and cost-efficient manner and is suitable for mass production. Further, the interference reflective microscope system 25 according to the invention comprises general and commonly use equipment in biological studies. Further, use of the system 25 with live cells is feasible. Prefixing or staining of the cells is not necessary.

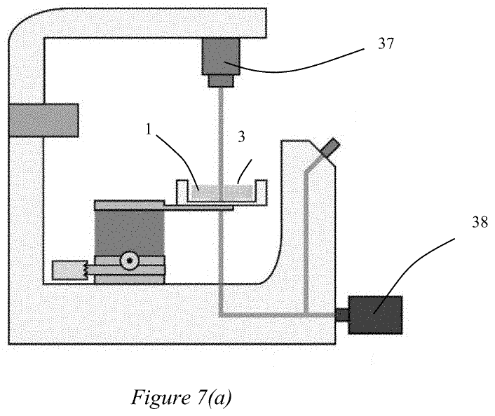

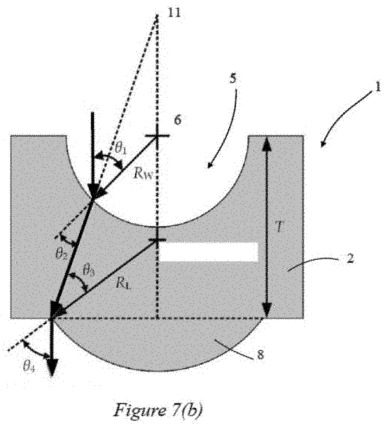

Shown in FIG. 7(a) in vertical cross section is a brightfield microscope system 36 according to the invention. The brightfield microscope system 36 again comprises the sample plate 1 for a microscope as shown in FIG. 1. The brightfield microscope system 36 further comprises a monochromatic light source 37 which is configured to illuminate the concave recess 35 in a direction substantially normal to the first face 3 as shown. The brightfield microscope system 36 further comprises an optical imaging system 38, in this case a camera, which receives the light transmitted through the sample plate 1 and forms an image.

When the sample plate 1 is employed as part of a brightfield microscope system 36 fixation and dehydration of the cell sample is required.

FIG. 7(b) shows, a portion of the sample plate 1 of the brightfield microscope system of FIG. 7(a). As can be seen, for this sample plate 1 the focal point 11 of the lens 8 is spaced apart from the center of curvature 6 of the recess 5.

As discussed above, the interference reflection microscope system 25 according to the invention can be employed with live cells. By way of specific example the system 25 was employed to quantify the cell initial spreading dynamics of human breast cancer cells (MDA-MB-231). Before seeding the cells a confocal dish pre-coated with fibronectin was rinsed with 100% ethanol, 50% ethanol and then phosphate buffered saline (PBS) for sterilisation. The MDA-MB-231 cells were then seeded in the recesses 5 of a sample plate 1 according to the invention at a density of around 3*10³ cell/cm²

Reflected and transmitted images were then captured using the first and second photomultiplier tubes 29, 30 every two seconds for 15 minutes. From the collected images it can be seen that the cell adherent area increases steadily. Compared with cell spreading on a flat PDMS surface, MDA cells exhibited a greater rate of spreading on a flat surface than in a recess 5.

1. A sample plate for a microscope comprising:
an optically transparent substrate comprising first and second faces;
the first face comprising a recess wall defining a concave recess for receiving a microscope sample; and,
a lens extending from the second face, the lens being defined by a lens face;
the lens being arranged opposite the recess.

2. A sample plate as claimed in claim 1, wherein the lens extends integrally from the second face.

3. A sample plate as claimed in claim 1, wherein the recess wall is shaped as a portion of the surface of a sphere.

4. A sample plate has claimed in claim 3, wherein the lens face is shaped as a portion of the surface of a sphere.

5. A sample plate as claimed in claim 4, wherein the lens and the recess are dimensioned such that the focal point of the lens coincides with the center of curvature of the recess.

6. A sample plate as claimed in claim 4, wherein the lens face extends from a lens face edge to a lens face center, the lens being dimensioned such that when measured at the center of curvature of the lens, the angle between the lens face edge and the lens face center is less than π/4 radians.

7. A sample plate as claimed in claim 1, wherein the recess is a groove and the lens is a ridge, the groove and ridge extending along a length direction.

8. A sample plate as claimed in claim 7, wherein the recess wall is shaped such that in a plane normal to the length direction the recess wall is a portion of a circle.

9. A sample plate as claimed in claim 8, wherein the lens wall is shaped such that in the plane normal to the length direction the ridge wall is a portion of a circle.

10. A sample plate as claimed in claim 9, wherein the lens and the recess are dimensioned such that the focal point of the lens coincides with the center of curvature of the recess.

11. A sample plate as claimed in claim 9, wherein in the plane normal to the length direction the lens face extends from a lens face edge to a lens face center, the lens being dimensioned such that when measured at the center of curvature of the lens the angle between the lens face edge and the lens face center is less than π/4 radians.

12. A sample plate has claimed in claim 1, wherein the substrate is a silicon based organic polymer, preferably polydimethylsiloxane.

13. A sample plate as claimed in claim 1, wherein the first face comprises a plurality of recess walls defining a plurality of spaced apart recesses, the sample plate further comprising a plurality of lenses extending from the second face, each lens being arranged opposite a recess.

14. An interference reflective microscope system comprising:
a sample plate as claimed in claim 1;
a monochromatic light source configured to illuminate the lens in a direction substantially normal to the second face; and,
an optical imaging system configured to receive the light reflected from the lens in a direction substantially normal to the second face.

15. An interference reflection microscope system as claimed in claim 14 wherein the monochromatic light source comprises a laser.

16. An interference reflection microscope system as claimed in claim 14 wherein the monochromatic light source comprises a confocal scanning laser system.

17. An interference reflection microscope system as claimed inclined 14 wherein the optical imaging system comprises a photomultiplier tube.

18. An interference reflection microscope system as claimed in claim 14, comprising a second optical imaging system configured to receive light from the monochromatic light source transmitted through the sample plate.

19. A brightfield microscope system comprising:
a sample plate as claimed in claim 1;
a monochromatic light source configured to illuminate the concave recess in a direction substantially normal to the first face; and,
an optical imaging system configured to receive the light transmitted through the sample plate.
